(19) United States
(12) Patent Application Publication
(10) Pub. No.: US 2002/0029203 A1
(43) Pub. Date: Mar. 7, 2002

(54) Electronic personal assistant with personality adaptation

(76) Inventors: David M. Pelland, Bolton, MA (US); Ruth Y. Pollock, Newton, MA (US); Eugenia S. Gillan, Andover, MA (US)

Correspondence Address: GARY WALPERT, Hale & Dorr, 60 State Street, Boston, MA, 02109, US

(21) Appl. No.: 09/847,855

(22) Filed: May 2, 2001

Related U.S. Application Data
(60) Provisional application No. 60/230,296, filed on Sep. 1, 2000.

(51) Int. Cl. G06F 15/18

(52) U.S. Cl. 706/12

(57) ABSTRACT

An electronic personal assistant that modifies a personality it projects through voice prompts and interaction with a subscriber based on subscriber behavior and communication. The personality is defined in terms of personality parameters. The values of the personality parameters are modified to enhance the relationship between the subscriber and the electronic personal assistant over time.

### CROSS REFERENCE TO RELATED APPLICATIONS

This application claims priority from the following U.S. Provisional Patent Application, the disclosure of which is incorporated by reference in its entirety for all purposes:

U.S. Provisional Patent Application Ser. No. 60/230,296, entitled, “Personality Adaptation of an Electronic Assistant,” filed Sep. 1, 2000.

### BACKGROUND OF THE INVENTION

This invention relates generally to computer-implemented electronic personal assistants.

Today there are many different commercially available electronic devices that assist people in communicating with each other. There are different types of telephones (e.g., cordless, mobile and handheld wireless phones), pagers, local and wide area computer networks, and facsimile machines, just to name a few. The number and variety of such devices continues to grow. Thus, there is also a growing need to find effective ways to coordinate and handle the electronic communications that such devices make possible.

One system that addresses this growing need is described in U.S. Pat. No. 5,652,789, incorporated herein by reference. The system described therein is referred to as an electronic personal assistant. It is a computer-implemented entity that assists a user (referred to as a subscriber) with his or her communications by carrying out certain tasks that are delegated to it. This electronic personal assistant recognizes speech and performs functions within the familiar model of an office.

### SUMMARY OF THE INVENTION

In one aspect, the invention features a method and computer program product for adapting an electronic personal assistant to a subscriber for whom the electronic assistant provides services. The method includes associating with a subscriber an electronic personal assistant personality defined by personality parameters and adjusting the personality parameters based on interactions with the subscriber over time.

In another aspect, the invention features a personal assistant system. The personal assistant system includes a personality unit, personality parameters stored in a database to which the personality unit is coupled and an interface coupled to the personality component for enabling interactions with a subscriber. The personality unit is configured to analyze the interactions with the subscriber and adjust the personality parameters based on the results of the analysis.

Other features of the invention will be apparent from the following detailed description and from the claims.

### BRIEF DESCRIPTION OF THE DRAWINGS

FIG. 1 is a block diagram of an electronic personal assistant (PA) having a personality unit that supports personality adaptation of a personality defined in terms of personality parameters.

FIG. 2 is a flow diagram of a process for configuring the personality unit to support a parameterized personality.

FIG. 3 is an illustration of the relationship between the two personality trait-based models, the “Five-Factor Model” and the “16PF Model”, from which the personality parameters are derived.

FIG. 4 is an illustration of the scope of variation of the variable 16PF Model factors for a subscriber and the PA.

FIG. 5 is an illustration of surface traits corresponding to the 16PF Model factors (or source traits).

FIG. 6 is an illustration of a mapping of surface traits to cultural definitions.

FIG. 7 is an illustration of cultural default levels for the surface traits shown in FIGS. 5-6.

FIG. 8 is a block diagram of the personality unit of FIG. 1.

FIG. 9 is a flow diagram of an exemplary personality adaptation process employed by the personality unit of FIG. 8.

### DETAILED DESCRIPTION

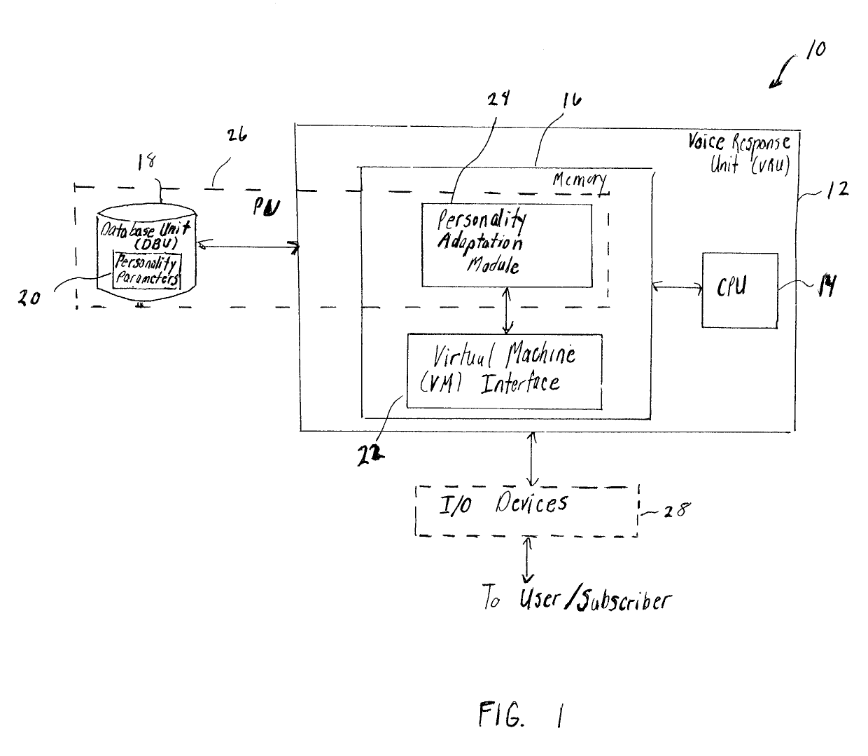

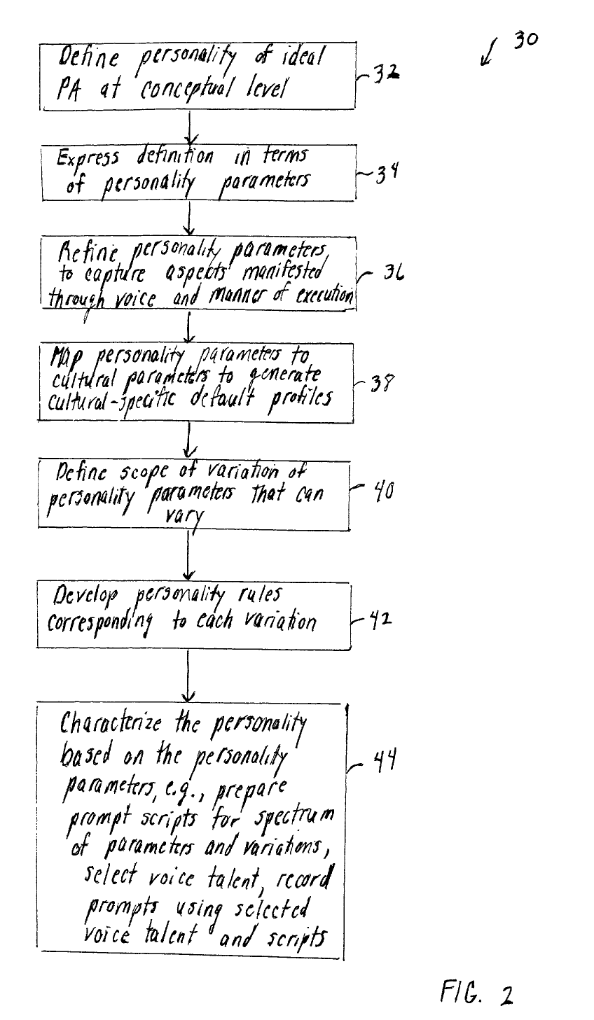

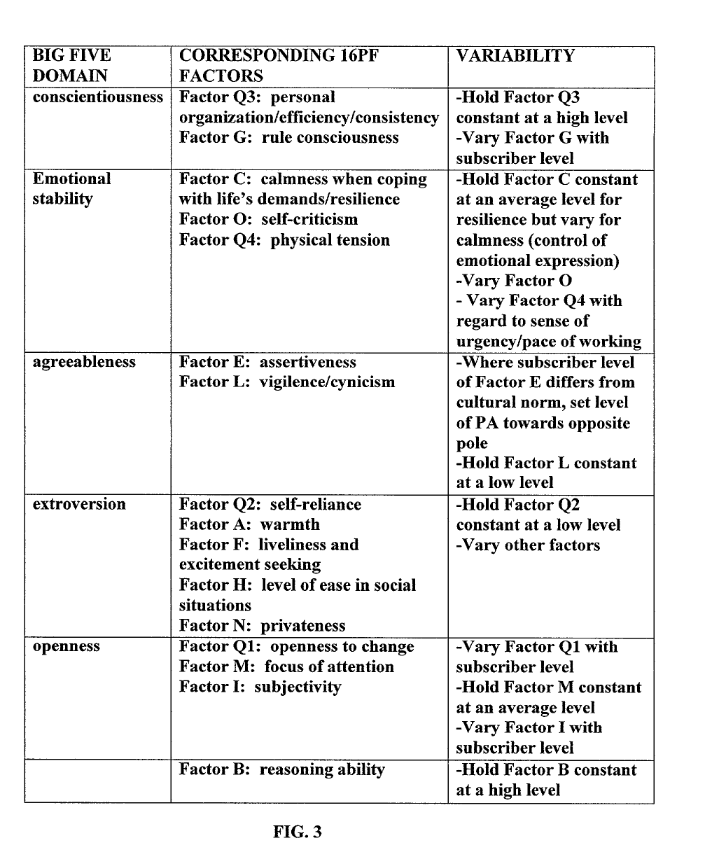

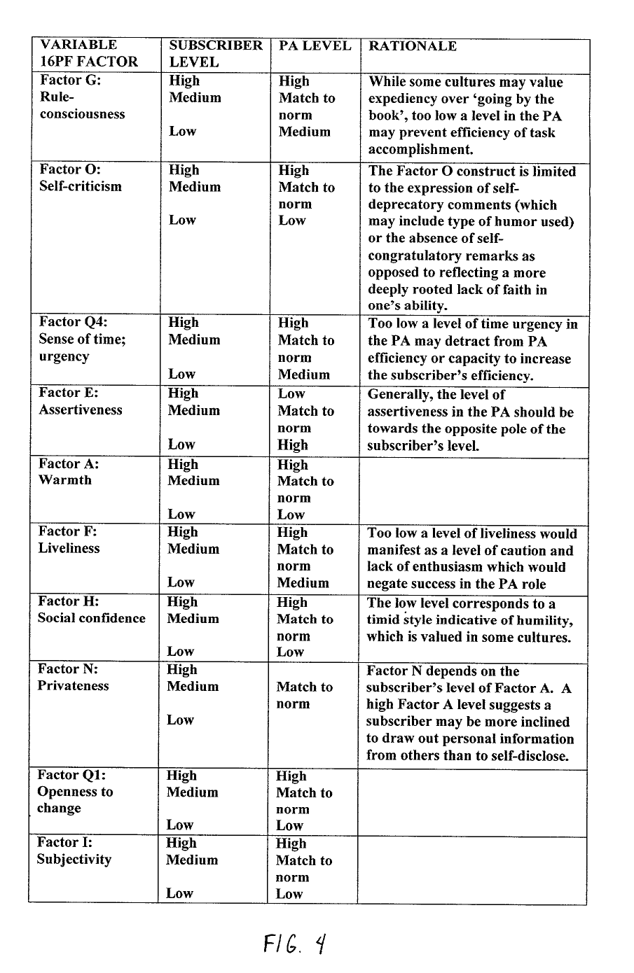

Referring to FIG. 1, an electronic personal assistant system (hereinafter, simply, personal assistant or “PA”) 10 includes a voice response unit (“VRU”) 12 that includes a processor 14 and a memory 16. The VRU is coupled to a mass storage device 18 implemented as a database unit (“DBU”). The DBU stores personality parameters 20, which will be described more fully below. The PA 10, or more particularly, the VRU 12, is coupled to various I/O interfaces (not shown) for communicating with a user or subscriber. Stored in the memory 16 and executed on the processor 14 are system software, including an event processing process referred to as a Virtual Machine (VM) interface 22 and PA personality adaptation module 24, as well as other known system software components such as an operating system (not shown). The DBU 18 and the personality adaptation module 24 are referred to collectively herein as a personality unit (PU) 26.

The VM interface 22 allows a user to interact with the PU 26 via external communications input/output (“I/O”) device interfaces 28 (indicated in dashed lines), such as telephone line cards and networking (e.g., LAN, Internet) devices. Although the I/O device interfaces 28 are not part of the PA 10 as depicted in FIG. 1, it will be appreciated that such device interfaces could be integrated with the VRU 12. The VM interface 22 includes interface functionality appropriate for handling input received from and output provided to the I/O device interfaces. Such functionality can include, for example, speech recognition and semantic analysis for automatic and natural speech processing, text-to-speech, as well as support for recorded speech output and text input. Further details of the VM interface 22 and exemplary I/O device interfaces through which a user interacts with the VM interface 22 may be had with reference to U.S. Pat. Nos. 5,652,789 and 6,047,053, entitled “Network Based Knowledgeable Assistant”; and U.S. Pat. No. 6,021,181, entitled “Electronic Voice Mail Message Handling System,” all of which are incorporated herein by reference.

The personality unit 26 provides a personality for the PA that is defined in terms of the personality parameters 20, which correspond to different personality traits. An understanding of the role of a personal assistant enables those personality traits most important to promoting effective performance in that role to be specified. Such an understanding recognizes that some aspects of the personal assistant's role (and, therefore, some personality traits) can be generalized across all settings in which the role might exist while others may vary. In other words, some personality traits considered ideal in one setting could differ from those considered ideal in another.

Also recognized is the notion that the traits deemed “ideal” for a given setting can change with time, as a subscriber's initial assessment of the appropriateness of the PA style is subject to the same dynamic forces that influence judgments about people in every day life. In every day life, people are constantly making judgments about other people's personalities and using those judgments to guide their interactions. The accuracy of initial assessments is impacted due to the fact that people know they are being evaluated and may control how their personality traits are revealed according to what they believe will give a good impression. As the relationship progresses, those involved in the relationship tend to feel more comfortable with each other and thus tend to reveal more of themselves. Whether the emergence of additional traits (actually, the emphasis of traits that may have been de-emphasized at the outset of the relationship) enhances or detracts from the effectiveness of the relationship depends on the mutual compatibility between the emerging traits of each party.

Accordingly, in a relationship between the PA 10 and a subscriber, the traits of the PA 10 are chosen to best fit (that is, match or complement) those traits emerging from the subscriber over time. Personality theory provides a framework for matching the PA personality to the expectations of the subscriber at the outset of the relationship. That framework in conjunction with the adaptation mechanism enables the personality of the PA 10 to adapt to the individual subscriber's preferred style of interpersonal interaction based on what the PA 10 learns about that subscriber through observation and/or interaction over the course of the relationship.

The PA 10 also reflects how essential personality traits (de-rived from a job role analysis, as discussed above) manifest in the context of the interface 22. In one embodiment, the interface 22 provides for speech and style of task management as the primary forms of communication, but could also be adapted to allow the PA 10 to have a virtual visual presence that would allow communications of personality through virtual visual objects and perhaps through gesture. The extent to which and the manner in which personality is conveyed through speech includes both the content and also such non-verbal variables as pace and intonation. The overall presentation of the personality is also influenced by the approach that the PA 10 takes to task accomplishment. Thus, functionality may also contribute to the personality communications.

Overall, therefore, the PA 10 is a combination of speech user interface (what the PA says), services (what the PA does) and intelligence, including navigation, ability to learn, and so forth (how the PA does it). These three aspects together form the PA “persona”.

It is not enough to identify the aspects of key personality traits that can be transmitted between the PA 10 and the subscriber through the interface 22, however. Subscriber expectations regarding the style in which the role of the PA is executed are also influenced by culture, which can be based on nationality (National culture) and/or market segmentation (e.g., occupation, age, gender, or other differentiators, or combinations thereof), and possibly other factors as well. Consequently, the PA personality definition or parameterization scheme of the PA 10 is designed to take such differences into account. The key personality traits discussed earlier are therefore mapped into established parameters from differentiating styles of doing business in different cultures. In this way, it is possible to delineate personality profiles most likely to be suited to those cultures.

Referring to FIG. 2, a process for developing a parameterized PA personality 30 is shown. First, a personality of an ideal personal assistant is defined at a conceptual level (step 32). That definition is “parameterized”, that is, expressed in terms of stylistic parameters, including variable stylistic parameters needed to ensure the adaptability of the PA as discussed above (step 34). The parameters are further refined to capture those aspects of the personality that are manifested through voice and manner of execution (step 36). The resulting personality parameters are mapped to cross-cultural definitions based on research findings regarding how business is typically done in different cultures or countries to generate default cultural or national profiles (step 38). The scope of personality parameter variation is defined for each variable parameter within each cultural profile (step 40). The personality scenarios (rules) corresponding to each variation are written (step 42). Lastly, the personality is characterized (step 44) by performing various tasks, such as preparing prompt scripts for the supported personality spectrum represented by the personality parameters and any associated variations, selecting the voice talent to provide the voice to prompts as scripted and recording the prompts using the selected voice talent and scripts. A more detailed discussion of the underlying framework for parameterization of the PA personality follows.

Conceptually, the “ideal” PA is one that can be “all things to all people”. To achieve such an ideal requires that the PA be capable of the following: a) performing any tasks required by an individual subscriber in any market segment; b) adapting her style of task management to best fit the preferences of the individual subscriber; and c) adapting her interpersonal style to maximize compatibility with that of the individual subscriber. Thus, implementation of the ideal PA requires consideration of both abilities and style. Abilities relate to the range and complexity of the tasks that the PA is capable of executing. In effect, these capabilities reflect the assistant's intelligence, that is, the potential to learn, apply reasoning to solve problems, and so forth. While ability is defined by the tasks that the PA is capable of executing, style embodies the way in which the intelligence is used and how the results of the reasoning process are expressed (how she does what she is capable of doing and also how she interacts on a personal level with the subscriber). Some aspects of style may be identified as being essential attributes of the ideal PA across all contexts in which the role exists. For example, one would expect a PA to be efficient, cooperative and willing to deal with whatever domains the subscriber places upon her. Other aspects of style, however, need to vary to suit the differing needs of different subscribers and the varying needs of any one subscriber over time and in different situations.

To identify the aspects of style which are relevant to the PA personality, a framework which comprehensively accounts for all of the possible ways in which human behavior might vary, both in terms of how tasks are approached (“task-focused style”) and in terms of how people are dealt with (“interpersonal style”) is needed.

In one embodiment, the derivation of relevant personality parameters (the personality parameters 20 from FIG. 1) is As accomplished within the context of two well-established, empirically derived frameworks for describing personality: the Five-Factor Model (“FFM”) and the Sixteen-Factor Model (“16PF Model”). The widely acknowledged FFM framework includes five broad domains of behavior which together cover all stylistic dimensions which, when considered in combination with one another, make any one individual unique. The five factors include the following: extraversion; emotional stability; agreeableness; openness to experience; and conscientiousness. Extroversion pertains to social orientation. Emotional stability refers to emotional adjustment as expressed in feelings towards others, attitude to self and self-control. Agreeableness pertains to the role one assumes in relationships. The “openness to experience” factor relates to one's thinking style. Because the five factors each have a number of related sub-dimensions and thus represent broad aspects of work performance, links between personality and more specific criteria for job success may be missed when the broad five factors are considered without examining the sub-dimensions that relate to them.

The framework of the 16PF Model, developed by Raymond Cattell, incorporates a number of sub-dimensions of the FFM factors. That is, it defines each of the five broad factors in terms of more narrowly focused aspects of personality. The Cattell model assumes that 16 factors are needed to comprehensively describe the whole of the human personality and account for variations between people in the way that they behave. The 16-factor framework thus provides a more refined or granular representation of a given personality.

The relationship between the 16PF Model and the FFM is illustrated in FIG. 2. Some personality traits are held constant across all of the contexts within which the PA is likely to operate, while others vary across situational contexts, for example, based on culture (market segment or National) or diversity of situations for individual subscriber, such as business versus home/leisure. Although some underlying traits remain relatively stable over time, there could be a variation in the extent to which they are shown and the manner in which they are shown. As noted in FIG. 2, six of the sixteen factors in the 16FP Model framework are identified as constants, that is, factors to be held constant across all settings within which the PA may work. They include the following: Factor Q3 (personal organization/efficiency/consistency); Factor C (calmness/resilience); Factor L (vigilance/cynicism); Factor Q2 (self-reliance); Factor M (focus of attention); and Factor B (reasoning ability). For optimum results, the other 10 factors are tailored to the specific preferences of the subscriber. The variable factors include factors Factor G (rule consciousness), Factor 0 (self-criticism), Factor Q4 (physical tension), Factor E (assertiveness), Factor A (warmth), Factor F (liveliness and excitement seeking), Factor H (level of ease in social situations), Factor N (privateness), Factor Q1 (openness to change) and Factor I (subjectivity). The combination of fixed (or global) parameters and variable parameters for a given subscriber results in a subscriber profile.

How the PA style is matched to that of the subscriber for the variable parameters depends on how the term “subscriber” is defined. A “subscriber” may be defined on all or any of three levels: as a member of a particular Nation; as member of a particular market segment with a National group; or as an individual within a market segment within a National group. When the focus of the profile is at the first two levels (national or market segment culture), one would expect the PA style to match the profile since a PA operating at these two levels is adopting a style typically expected of a particular group. When the focus is at the third level, the PA style will not necessarily be the mirror image of the individual subscriber since, at the individual level, the PA is interacting rather than fitting a typical profile. In other words, to fit a national profile or market segment profile, the PA needs to behave in ways that are typical in that culture. To fit an individual, however, the PA needs to adapt to the preferences of that individual with respect to how others interact to suit the preferences of that individual, which may not necessarily mirror the individual's style.

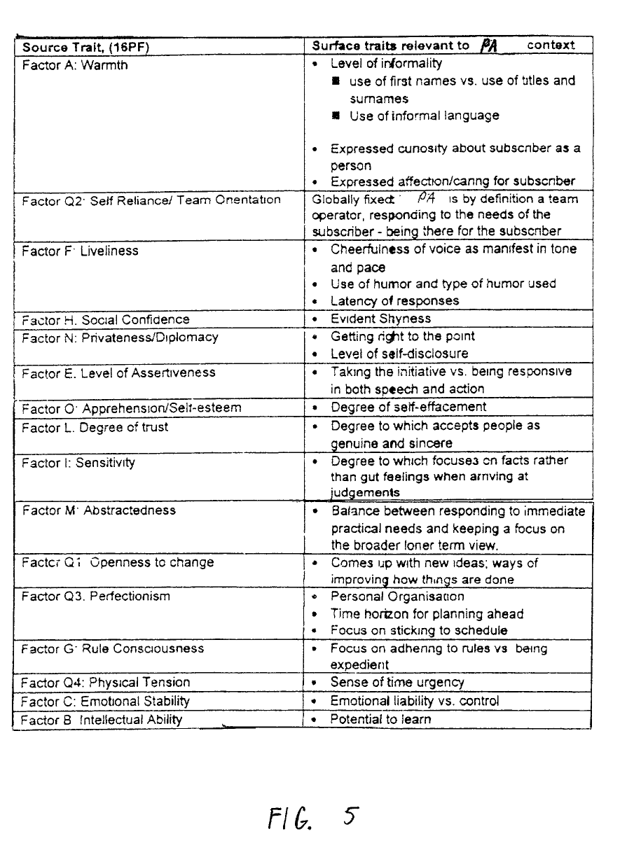

In general terms, not all personality traits are equally important to all subscribers. Those personality traits which any individual subscriber views as most important, and therefore need most careful matching, may be those which are most pronounced in the subscriber. Those traits that exist at an average or medium level in the subscriber's profile will carry less weight in the subscriber's evaluation of the PA's style. For those traits on which the individual falls within the average for the National group or market segment to which the individual belongs, the PA 10 adopts the style most suited to the cultural norm. Where the individual subscribers deviate from the cultural norm for a particular trait, the PA 10 advantageously adopts a style that is most suited to interacting with a subscriber who possesses that trait. FIG. 4 illustrates an exemplary PA style adaptation at the level of individual variation in the 16PF Model factors.

The FFM domains and the factors that contribute to the 16PF model are underlying factors that influence the manifestation of personality. They are not themselves observable, but are instead the source of observable behavior. As such, they are referred to as “source traits”. The observable behaviors that result from the influence of these source traits are referred to as “surface traits”. Each source trait is associated with a range of surface traits. It is necessary to identify those surface traits most likely to represent different levels of the source traits in the context of the PA 10. If the primary expression of personality is through the voice, it is desirable to select those surface traits that are most easily transmitted through the voice. FIG. provides the one or more surface traits identified as best representing each source trait (16PH factor) relevant to the job role of the PA 10. For example, for the source trait ‘warmth’, the relevant surface traits include: level of informality, which includes use of first names versus use of titles and surname, as well as use of informal language; expressed curiosity about the subscriber as a person; and expressed affection/caring for the subscriber.

The personality parameters or surface traits are assigned default values for each context to which they are applied. These default values are used to define the personality and personality variation for each culture. To enable the PA to adapt to different cultural styles for interacting in a business environment, the personality parameters are mapped to cultural parameters identified in research literature concerning how business is typically conducted in different National cultures. Relevant cultural parameters include the following:

PD: Power Distance—Power Distance reflects the level of egalitarianism versus social hierarchy. Low PD indicates a high level of egalitarianism, while high PD translates to a hierarchical society, with significant power differences between different levels of the social hierarchy.

TA: Tolerance for Ambiguity/UA: Uncertainty Avoidance—TA and UA indicate the extent to which members of a culture feel threatened by uncertain or unknown situations.

IDWC: Individual Differences Within Cultures

I/C: Individualism/Collectivism—Individualism pertains to societies with loose ties among individuals. Each person is expected to take care of himself/herself. In contrast, collectivism pertains to societies in which people from birth onwards are integrated into strong, cohesive groups, which offer them support and protection in exchange for loyalty.

F/M: Femininity/Masculinity—Masculinity pertains to societies in which social gender roles are clearly distinct. Femininity pertains to societies in which social gender roles overlap.

I/L: Initiative Taking/Listening

Har/Clar: Harmony/Clarity—This dimension pertains to the extent to which cultures either attempt to control or adapt to their environments.

FTO: Future Time Orientation—The FTO dimension pertains to a society's search for virtue, in the long run.

LA/MA: Linear Active/Multi-Active—The LA/MA dimension pertains to information processing (linear versus nonlinear) and communication styles.

A/N: Affective/Neutral—This dimension pertains to degree to which a culture tolerates open expression of emotion.

Expr/Res: Expressive/Reserved—This dimension pertains to degree to which a culture tolerates open self-expression.

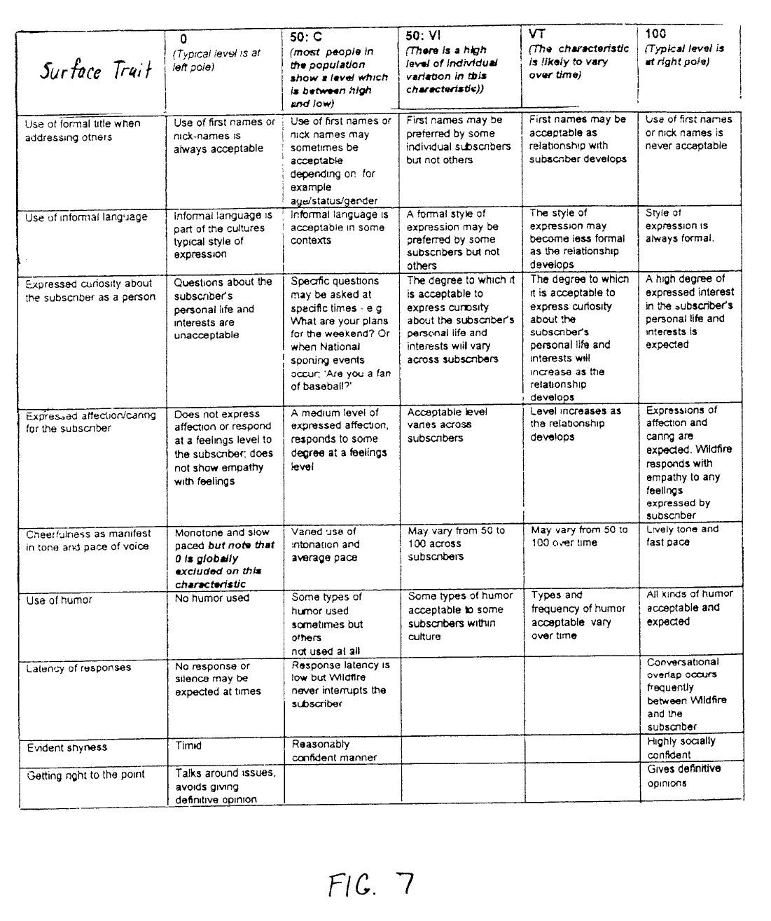

The relationship between the personality parameters of the PA, that is, the surface traits corresponding to the 16PF factors, and cultural definitions (different combinations of one or more of the earlier described cultural parameters) are shown in FIG. 6. This relationship allows values for the personality parameters for different National cultures to be identified.

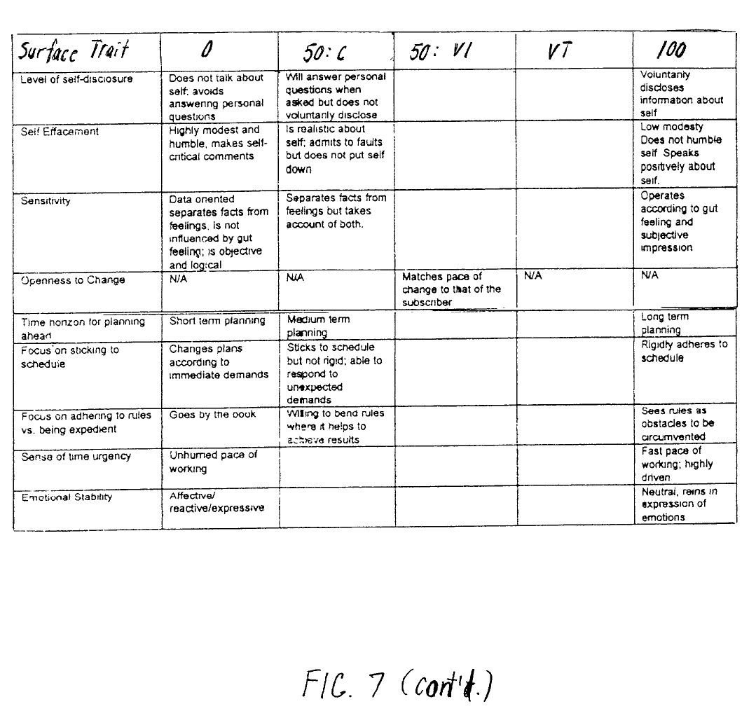

As illustrated in FIG. 7, the values correspond to default personalities for each National culture (that is, the profile that most typifies the style of each Nation). The values are stated in terms of range between low (left pole) and high (right pole). The information that the assigned values communicate about each parameter is as follows: the value ‘0’ indicates that the characteristic is prominent within the culture and manifests as it is defined at the left pole; the value ‘50: C’ indicates that most people in the culture show a level which is not extreme, i.e., they are between the extreme left and right poles; the value ‘50: VI’ indicates that there is a high level of individualism such that a typical level cannot be defined, that is, there is likely to be considerable variation among subscribers; the value ‘VI’indicates that the trait is likely to show progressive adaptation over time; and the value ‘100’ indicates that the trait is salient within the culture and manifests as it is defined at the right pole. Subscribers belonging to a particular Nation will not necessarily be typical of their National profile in every respect.

Thus, the personality-to-cultural parameter mapping allows nation-specific information regarding how style varies within the culture to be expressed in a cultural profile. The cultural profile provides for a particular culture a core (default) personality and a description of how and why that personality changes. The variations are coded in rules that define the methods of observation and interaction required to assess changes to be made to the PA on behalf of a subscriber.

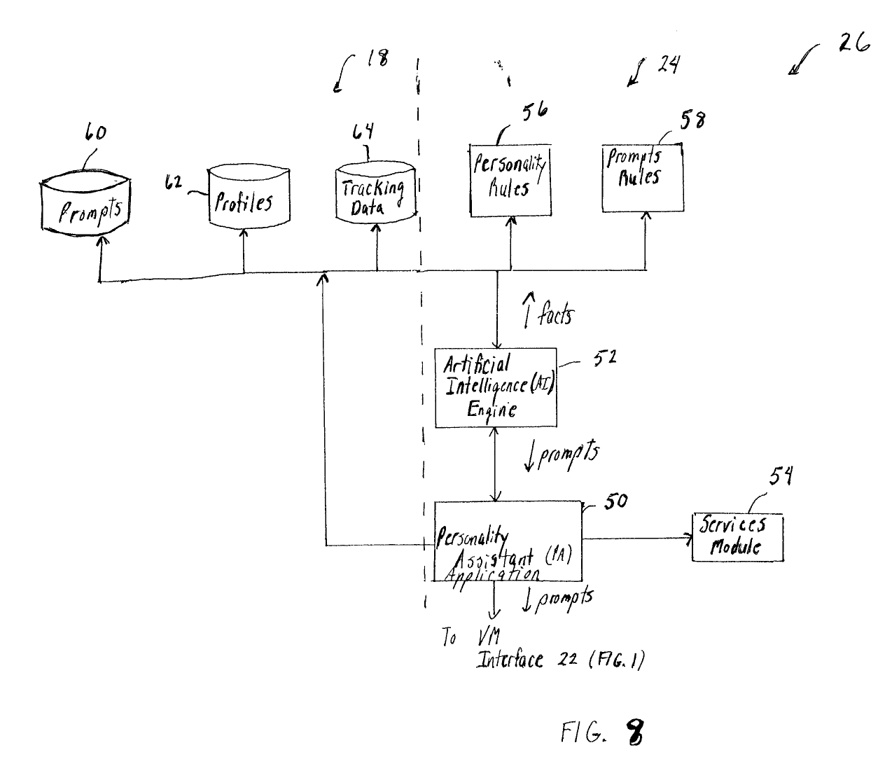

Referring now to FIG. 8, the personality adaptation software 24 and DBU 18 of the personality unit 26 are shown in some detail. The software 24 includes a PA application 50, which is coupled to and receives processed subscriber input from the VM interface 22 (FIG. 1). The processed subscriber input corresponds to a subscriber situation (e.g., subscriber asks for messages) or observation of subscriber behavior (e.g., subscriber signals a request for a service). Coupled to the PA application 50 is an artificial intelligence (AI) unit 52, which analyzes the situation or behavior information (e.g., the subscriber question as heard by the VM interface 22) received from the PA application 50. In one embodiment, the AI unit 52 is implemented as the Eclipse inference engine, available from The Haley Enterprise, Inc. Other commercially available AI engines could also be used. Also connected to the PA application 50 is a services module 54, which defines functionality provided by the VRU, for example, fax, e-mail, voice mail, address book.

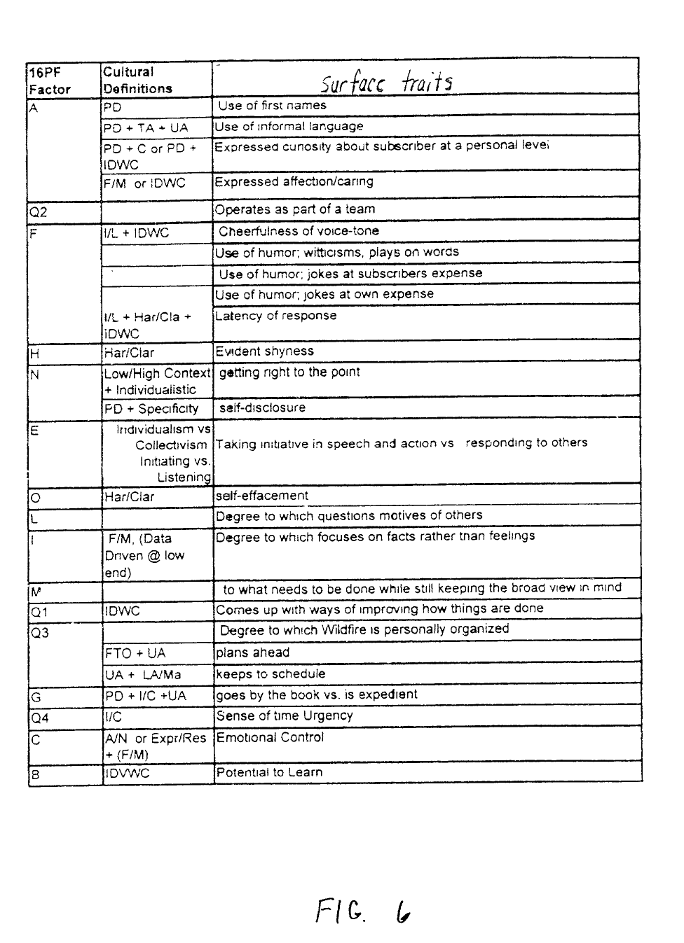

The AI engine 52 is connected to two rules-based units, personality rules 56 and prompts rules 58, as well as the DBU 18. As shown, the DBU 18 stores prompts 60, profiles 62 and tracking data 64. Although not shown, the DBU 18 can include other information as well, e.g., a general repository of external knowledge that may be useful to the PA application 50. The rules-based design supports personality parameterization within a given voice. It uses a set of personality parameters, including twenty-seven parameters based on the 16PF Model factors and incorporating the relevant surface traits (from FIG. 5), and rules (personality scenarios) for each personality parameter variation. Initially, the personality parameters are set to default (or norm) values. The personality rules 56 include one or more rules for each personality parameter or trait. The logic in the rules determines which parameters are to be used to select an appropriate prompt or prompts for a given situation. Preferably, the prompts 60 include a different set of voice prompts for each nationality profile. Files containing the prompts are organized by voice, with a different voice used for each nationality profile. The tracking data 64 maintains a historical record of the subscriber's utterances (types of commands, requests, etc.) as well as maintains a subscriber diary that reflects the subscriber's activities relative to the PA over time, e.g., how many times the subscriber requested that a particular phone call be made, how many times a particular prompt was heard, and so forth.

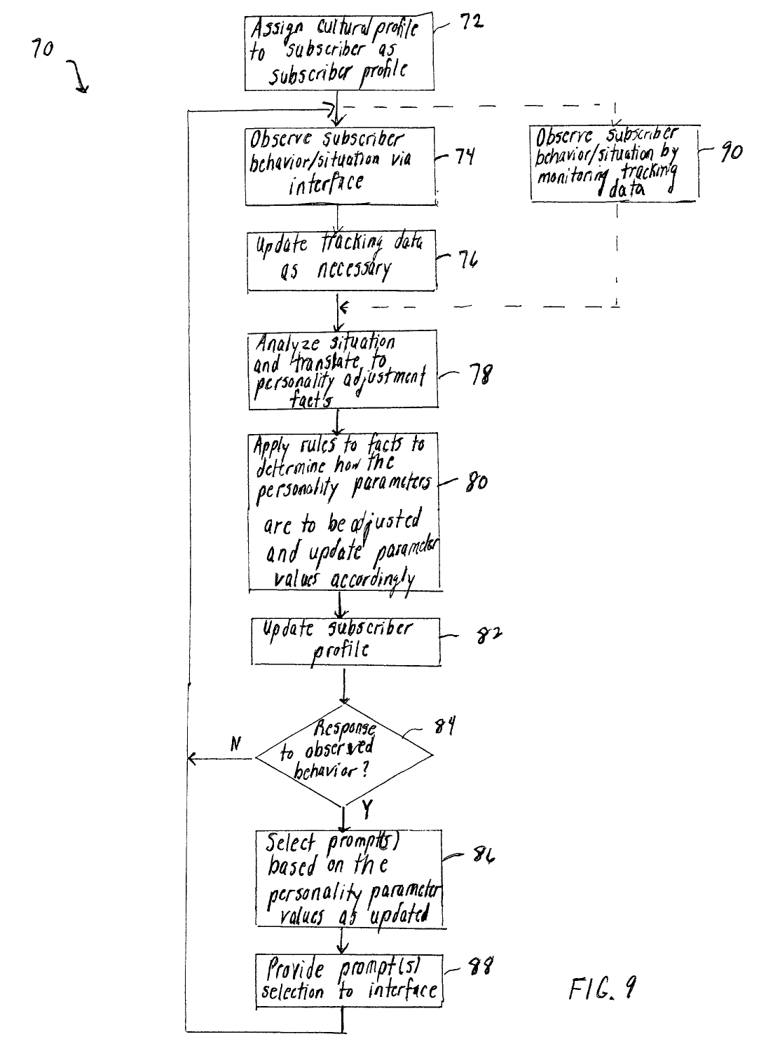

Referring to FIG. 9, a personality adaptation process 70 performed by the personality adaptation module 24 operates to adapt the personality provided by PU 26 in the following manner. The process 70 assigns a cultural profile to the subscriber as a subscriber profile (step 72). Thus, at the beginning of the PA/subscriber relationship, the subscriber is provided with a set of personality parameter values based on the default values of the selected profile. The process 70 observes the subscriber's behavior or situation (“subscriber contact”) via the interface 22 (step 74). The process 70 updates the tracking data as necessary (step 76). The process 70 analyzes the observed situation or behavior and translates that observed contact into facts that are useful to the rules 56, 58 (step 78). The process 70 applies the rules 56 to the facts to determine how the personality parameters are to be adjusted and changes the values of the personality parameters accordingly (step 80). The process 70 also updates the stored subscriber profile for the new values (step 82). If the process 70 determines, based on the nature of any situation or behavior that was observed, that a response to is expected (step 84), the process 70 selects one or more prompts based on the personality parameters as adjusted (step 86) and provides the selected one or more prompt to the interface 22 (step 88).

The parameter adjustments are made based not only on current observations (or interface input activity) but tracking data collected over time. Thus, and still referring to FIG. 9, the process 70 observes trends in subscriber contact (that is, behavior or situation) by monitoring the tracking data (step 90). The monitoring of tracking data can occur concurrently with the receipt of input data at the interface or in absence of any input activity at the interface. For tracking data observations, the process 70 performs steps 78 through 84 and, since a response is not expected, returns to the steps of observing subscriber behavior 72, 90. Likewise, after step 88, the process 70 returns to the steps 72, 90.

In addition to using the tracking data to detect trends in usage by an individual subscriber, the PA also has the capability to examine the tracking data for trends within defined groups of subscribers. Preferably, this type of analysis is done automatically as a background process. The results of this analysis can be used to fine-tune the granularity of the variations on a per-cultural-profile, per-trait-specific basis. The PA can even fine-tune the norm values if, over time, the collective subscriber data for subscribers associated with the same cultural profile suggest that the original norm values were inaccurate or, alternatively, suggest a cultural change.

The adjustments and profile updates can occur in real-time, as described above with respect to FIG. 9. Alternatively, for performance or other reasons, it may be desirable to postpone the parameter adjustments and/or profile updates, for example, schedule them to occur during off-hours or at other times of when subscriber system usage is fairly low.

An example of how the personality parameters may change with time is as follows. At an initial stage in a relationship with a subscriber, the PA may present a personality that includes the following parameter settings: a high level of formality and liveliness surface traits, and a low level of those surface traits corresponding to humility and emotional support. The formality is evident in how the subscriber is addressed. Also, no colloquialisms are used. The liveliness and enthusiasm temper the precision and ‘strait-laced’ quality of the formality. The formality tempers the use of hyperbole. ‘Funny’ remarks are still made but in a low-key way and never at the expense of the subscriber. The voice of the PA has a light-hearted tone. While polite, the PA is authoritative and self-assured, with frequent usage of ‘I’. The PA treats the subscriber as an equal and readily voices opinions, but her formal style causes her to be less likely to express curiosity about the subscriber's life and recent activities. The PA politely acknowledges the subscriber's feelings but won't try to counsel the subscriber.

As the PA observes the subscriber's style, that is, the manner in which the subscriber interacts with the PA, including the content of any communications, the PA may determine the subscriber prefers a more informal interaction with the PA as well as prefers to have a more dominant, authoritative role in the relationship. Thus, the PA adjusts the parameters reflective of degree of formality and humility to present to the subscriber a personality that has a lower level of formality and higher level of humility. Subsequently, the PA addresses the subscriber informally and use colloquial phrases. A genuine interest in getting to know the subscriber is evident in small talk, which includes personal questions about the subscriber's life and recent activities. The PA tends to come across as light-hearted, energetic and funny. The PA makes jokes, uses hyperbole and laughs frequently. At the same time, she is deferential rather than dominant. She is apologetic and her humor is self-deprecating. She still won't engage the subscriber about feelings in any depth.

The architecture is designed to support personality parameterization within a give voice. Additionally, the architecture can support the ability to switch between voices. The voice switching is achieved by selecting a different voice prompt file and perhaps personality rules set as well. Parameter values can remain unchanged or be re-initialized to default values.

Other embodiments are within the scope of the following claims.

What is claimed is:

1. A method of adapting an electronic personal assistant to a subscriber for whom the electronic personal assistant provides services, comprising:
associating with a subscriber an electronic personal assistant personality defined by personality parameters; and
adjusting the personality parameters based on interactions with the subscriber over time.

2. The method of claim 1, further comprising:
providing profiles, each of the profiles defining a value corresponding to a default value and a variation from the default value for each of the personality parameters.

3. The method of claim 2, wherein each profile corresponds to a culture and the default value corresponds to a cultural norm associated with the culture.

4. The method of claim 3, wherein each profile further corresponds to a market segment and the default value corresponds to a market segment norm.

5. The method of claim 4, further comprising:
selecting one of the profiles for the subscriber.

6. The method of claim 1, further comprising:
defining the personality parameters to include personality traits.

7. The method of claim 6, wherein the personality traits are based on factors of the 16PF Model.

8. The method of claim 7, wherein the personality traits are represented as one or more surface traits.

9. The method of claim 5, wherein adjusting comprises:
observing a contact from the subscriber;
analyzing the observed contact; and
modifying the values of the personality parameters according to the defined variation based on the analysis of the observed contact.

10. The method of claim 9, wherein the personality parameters are mapped to sets of rules.

11. The method of claim 10, wherein analyzing comprises:
applying rules within the sets of rules to the observed contact.

12. The method of claim 10, wherein analyzing further comprises:
applying an artificial intelligence inference algorithm to the observed contact.

13. The method of claim 12, wherein the variation associated with each personality parameter comprises a range of the values and the values within the range of values are associated with unique voice prompts.

14. The method of claim 13, wherein adjusting further comprises:
selecting a new one of the personality parameters values based on the application of the artificial intelligence inference algorithm and the rules; and
selecting one of the unique prompts associated with the selected new one the personality parameters values.

15. The method of claim 14, further comprising
monitoring the electronic assistant personality adjusting; and
providing additional values and associated unique prompts based on the monitoring.

16. A computer program product residing on a computer readable medium for adapting an electronic personal assistant to a subscriber for whom the electronic personal assistant provides services, comprising instructions for causing a computer to:
associate with a subscriber an electronic personal assistant personality defined by personality parameters; and
adjust the personality parameters based on interactions with the subscriber over time.

17. A personal assistant system comprising:
a personality unit;
personality parameters stored in a database to which the personality unit is coupled;
an interface coupled to the personality component for enabling interactions with a subscriber; and
wherein the personality unit is configured to analyze the interactions with the subscriber and adjust the personality parameters based on the results of the analysis.

18. The personal assistant system of claim 16, wherein the personality unit is further configured to indicate a voice prompt selection based on the adjusted personality parameters.
